(19) United States
(12) Patent Application Publication
(10) Pub. No.: US 2008/0289188 A1
(43) Pub. Date: Nov. 27, 2008

(54) Retractable and Sanitary Food Buffet Utensil

(76) Inventor: Maria T. Holdbrooks, Hogansville, GA (US)

Correspondence Address: HARSHAW RESEARCH, INC., 210 W. TECUMSEH STREET, OTTAWA, KS, 66067, US

(21) Appl. No.: 12/187,158

(22) Filed: Aug. 6, 2008

Related U.S. Application Data
(63) Continuation-in-part of application No. 11/584,744, filed on Oct. 23, 2006.

(51) Int. Cl. B25F 3/00; A47J 43/28; B25B 9/00

(52) U.S. Cl. 30/123; 30/323; 30/326; 294/99.2

(57) ABSTRACT

A food buffet utensil for use with a food buffet having a shield includes a base member attachable to the food buffet shield. A housing is coupled to the base member and defines an open bottom. The food buffet utensil includes a cord having a first end connected to a reel and a second end extending therefrom, the reel being selectively movable between retracted and extended configurations. The food buffet utensil includes a utensil body having a handle coupled to the second end of the cord, the handle being displaced from the housing when the reel is at the extended configuration and a portion of the handle being positioned in the housing when the reel is at the retracted configuration. An ultraviolet LED is positioned in the housing such that ultraviolet light is emitted when the ultraviolet LED is electrically energized.

### CROSS REFERENCE TO RELATED APPLICATIONS

This application is a continuation-in-part application that claims the benefit of U.S. application Ser. No. 11/584,744 filed Oct. 23, 2006 entitled Food Buffet Retractable Utensil.

### BACKGROUND OF THE INVENTION

This invention relates generally to a food buffet retractable utensil and, more particularly, to a retractable food bar utensil for use with a food buffet that is both retractable and proactively sanitary.

In the restaurant industry, sanitation is critical to the success of the business and to the health of its patrons. This is especially important at a food buffet. At most food buffets and salad bars, a pair of tongs or a ladle rests in or on the food until the next patron picks it up for use. In use, the utensil may make contact with a user's plate, with other food items and, of course, with the user's hands. Accordingly, the food utensil may be repeatedly exposed to germs and bacteria and these undesirable items may then reside and develop on the utensil for a long period of time, potentially leading to food poisoning.

Various devices have been proposed in the art for maintaining sanitary conditions in and around a food buffet, such as the so-called “sneeze shield” over the food items and even means for holding food utensils away from the food. Regarding the use of retractable devices, the Oliver et al. patent (U.S. Pat. No. 6,419,413) discloses a writing instrument attached to a cord that is retractable into a housing. The Wax patent application (U.S. Pub. No. 2004/0006850) discloses a system of securing a pen so as to prevent accidental lost or theft. The Lieberman patent (U.S. Pat. No. 4,895,336) discloses a portable power tool having a retractable hook. The Kimball patent (U.S. Pat. No. 5,782,708) discloses a retractable golfing tool. The Paugh patent (U.S. Pat. No. 5,833,165) discloses a retraction reel for keys and the like. The Lombardo et al. patent (U.S. Pat. No. Des. 465,645) illustrates a design for a retractable utensil device.

Although assumably effective for their intended purposes, the existing devices do not adequately maintain or proactively promote the sanitation of a buffet food utensil. More particularly, the past proposals and existing devices do not keep a buffet utensil suspended above a respective food item when not in use and proactively sanitize the utensil while suspended.

Therefore, it would be desirable to have a retractable food buffet utensil that is suspended above a respective food item when not in use and may be extended to the food item when needed. Further, it would be desirable to have a retractable food buffet utensil that provides a sanitizing function while the food buffet utensil is retracted and not in use.

### SUMMARY OF THE INVENTION

A food buffet utensil for use with a food buffet having a food shield according to the present invention includes a base member attachable to the food buffet shield. A housing is coupled to the base member and defines an open bottom. The food buffet utensil includes a cord having a first end connected to a reel and a second end extending therefrom, the reel being selectively movable between retracted and extended configurations. The food buffet utensil includes a utensil having a handle coupled to the second end of the cord, the handle being displaced from the housing when the reel is at the extended configuration and a portion of the handle being positioned in the housing when the reel is at the retracted configuration. An ultraviolet LED is positioned in the housing such that ultraviolet light is emitted when the ultraviolet LED is electrically energized. A sensor may be included in the housing for detecting when the handle is within the housing and such that the ultraviolet light is activated only when the handle is present therein.

Therefore, a general object of this invention is to provide a food buffet utensil that is retractable above a respective food items on a food buffet so as to promote sanitary food service.

Another object of this invention is to provide a food buffet utensil, as aforesaid, in which the utensil is retractable from a housing that is securable to a food buffet shield in use and which automatically retracts substantially back into the housing when not in use.

Still another object of this invention is to provide a food buffet utensil, as aforesaid, that automatically activates ultraviolet lights to sanitize the handle of the utensil when the handle is retracted into the housing.

Yet another object of this invention is to provide a food buffet utensil, as aforesaid, that is user-friendly in use by patrons of a food buffet.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a plurality of retractable and sanitary food buffet utensils in use on a food buffet;

FIG. 2 is a food buffet utensil removed from the food buffet and illustrated in a retracted configuration;

FIG. 3 is a food buffet utensil removed from the food buffet and illustrated in an extended configuration;

FIG. 4 is an elevated perspective view of the food buffet utensil as in FIG. 2 with a base member top wall removed for clarity; and

FIG. 5 is a bottom perspective view of the food buffet utensil as in FIG. 2.

### DESCRIPTION OF THE PREFERRED EMBODIMENT

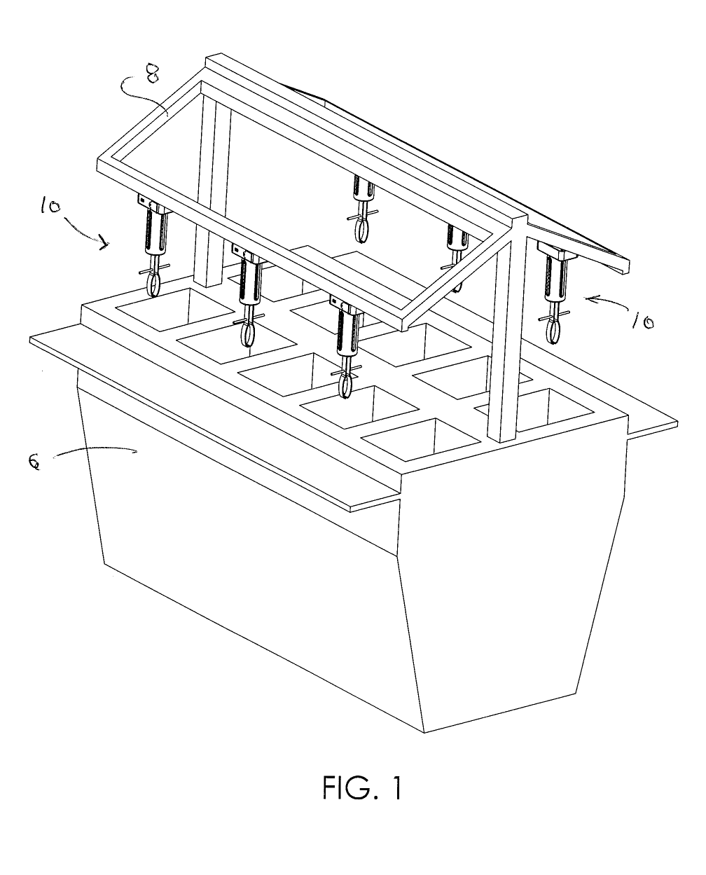

A retractable and sanitary food buffet utensil 10 for use with a food buffet 6 having a food shield 8 according to a preferred embodiment of the present invention will now be described in detail with reference to FIGS. 1 to 6 of the accompanying drawings.

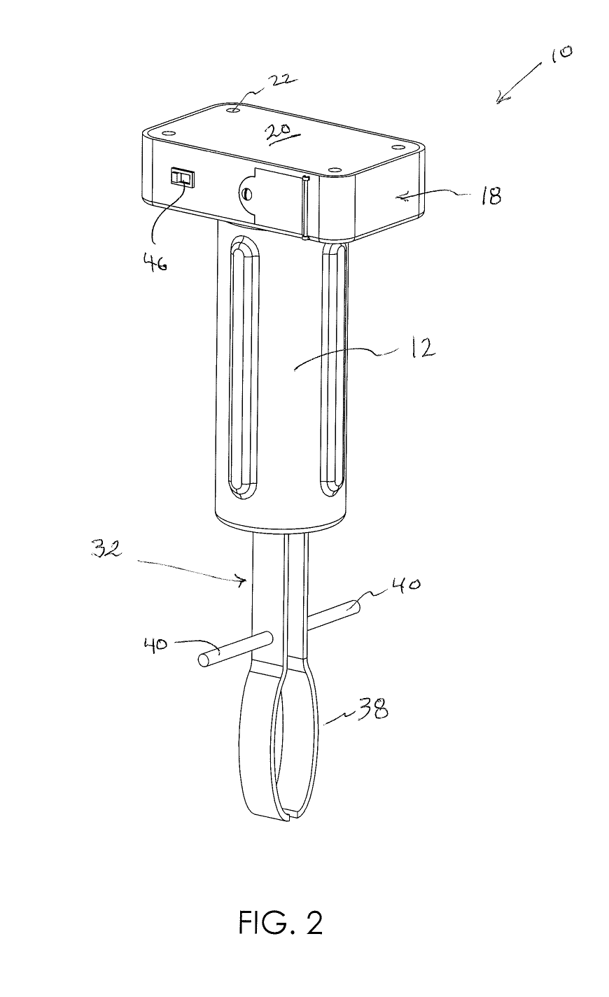

The retractable and sanitary food buffet utensil 10 includes a housing 12 having a continuous side wall defining a generally hollow interior space 14 and an open bottom 16 (FIGS. 2 and 6). Although the housing 12 is illustrated as having a tubular or cylindrical configuration, it is understood that other configurations would also be suitable.

A base member 18 is coupled to an upper end of the housing 12 and also defines an interior space for containing other components of the device as will be further described below. In other words, the base member 18 defines an interior space that is in operative communication with the interior space 14 of the housing 12. The top 20 and bottom 21 walls defines holes 22 through which fasteners may be inserted for fastening the base member 18 to a food buffet shield 8 (FIG. 1). While it is preferred that each base member 18 be securely fastened to the food buffet shield with screws or the like, it is understood that other suitable means for fastening the base member 18 thereto may also be utilized.

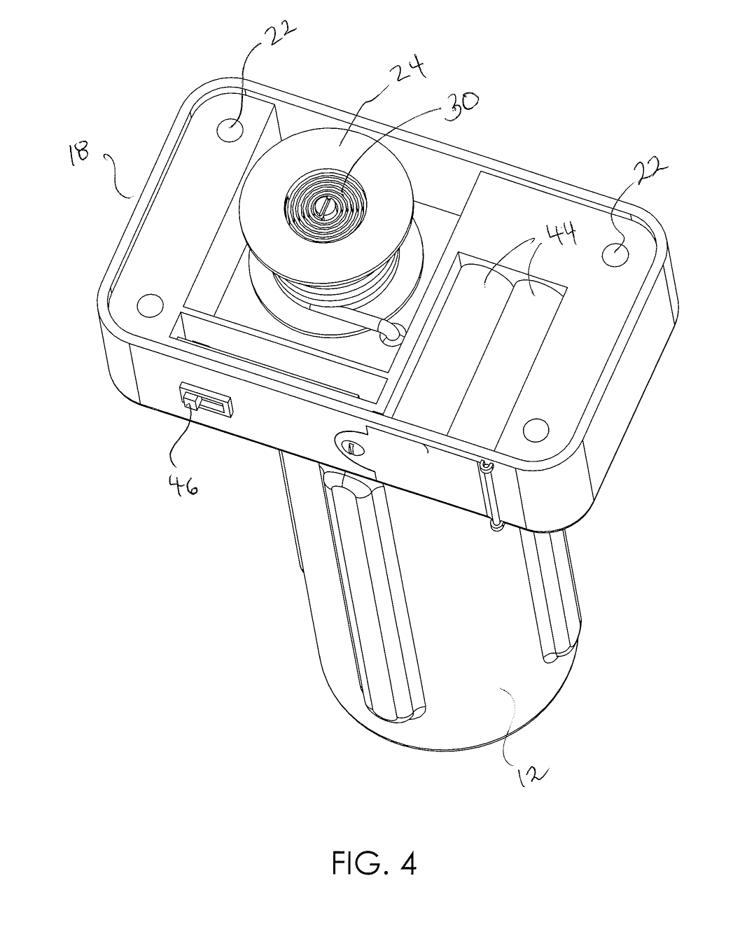

A reel 24 is rotatably mounted in the base member 18 (FIG. 4). A cord 26 includes a first end connected to the reel 24 and a second end 28 extending away from the reel 24 and into the housing 12. The reel 24 is movable between a retracted configuration in which the cord 26 is substantially wound about the reel 24 and an extended configuration in which the cord 26 is substantially extended from the reel 24 and into the interior space 14 of the housing 16 by passing through a hole in the base member bottom wall 21.

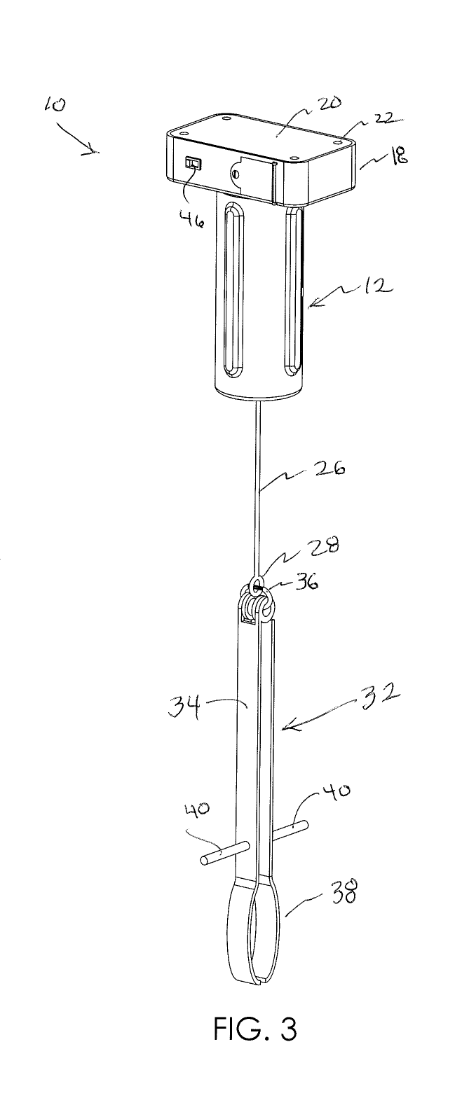

A spring 30 is situated in the base member 18 and coupled to the reel 24. More particularly, one end of the spring 30 is fixedly attached to a post extending upwardly from a base member wall and the other end is connected to the rotatable reel 24. The spring 30 is tightened as the reel 24 is moved from the retracted configuration to the extended configuration (FIG. 3) and is biased to return the reel 24 to its normally retracted configuration when the cord is no longer being pulled (FIG. 2).

The retractable and sanitary food buffet utensil 10 includes a utensil body 32 having a handle 34 (FIG. 3). The handle 34 is at one end (the “attachment end”) coupled to the second end 28 of the cord 26, the handle attachment end having a clasp 36 that is both pivotal and releasable relative to the cord second end 28. Opposite the handle attachment end is a utensil implement 38 selected from the group that includes a fork, a spoon, a ladle, and a pair of tongs. It should now be understood that the entire utensil body 32 is displaced from the housing 12 when in the extended configuration (FIG. 3), whereas at least the handle 34 is contained within the housing 12 at a retracted configuration (FIG. 2).

Preferably, a pair of oppositely disposed flanges 40 are fixedly attached to the handle 34 proximate the utensil implement 38, the flanges 40 extending outwardly from and generally perpendicular to a longitudinal axis defined by the handle 34 (FIG. 3). It would be suitable, however, for only one flange 40 to be present and may have any suitable configuration that enables a user to grasp it so as to sufficiently lower the handle 34 from the housing 12 to be grasped for use.

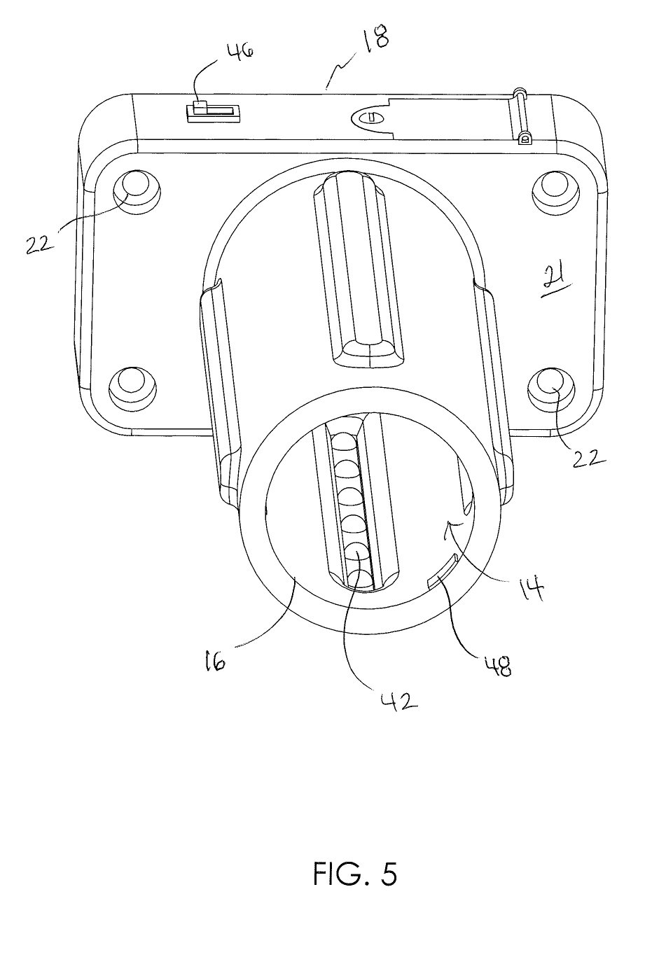

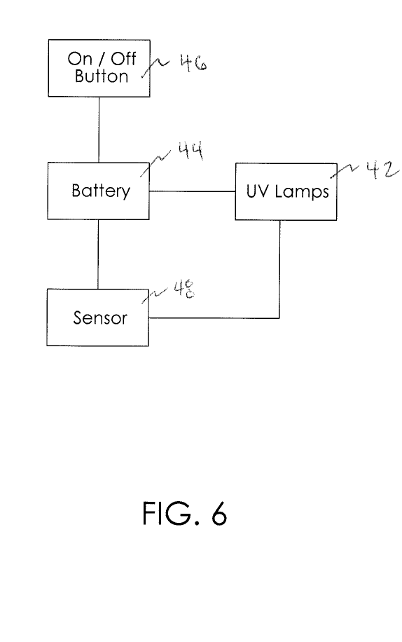

In a preferred embodiment, at least one ultraviolet LED 42 is mounted on an inner surface of the housing 12. Preferably, a plurality of ultraviolet LED's are situated in the housing 12 so as to substantially surround the handle 34 of the utensil body 32 (FIG. 5). The LED's are electrically connected to a battery 44 positioned in the base member 18 (FIG. 4). An on/off switch 46 is also positioned on the base member 18 and electrically connected to the battery 44 for selectively enabling current to flow from the battery 44. Therefore, the ultraviolet LED's emit ultraviolet light toward the handle 34 when the battery 44 is activated to energize the LED's 42. Ultraviolet light is effective for killing bacteria that may be on the handle 34 whenever the handle 34 is situated in the housing 12 and the ultraviolet LED's are activated.

In addition, a sensor 48 may be mounted to an inner wall of the housing 12 to detect when the handle 34 is returning or has completely returned to its resting position within the housing 12. Preferably, the sensor may be a motion sensor. The sensor 48 may be electrically connected to the battery 44 and ultraviolet LED's so as to enable the LED's to be energized when the sensor 48 detects an appropriate movement. As shown in FIG. 6, the electrical components of the present invention may be seen to form a circuit. If a sensor 48 is not included, then the UV lights may be energized according to the on/off switch 46 or, if the sensor 48 is included, by an appropriate setting of the switch 46 and sensor activation. It is understood that a processor or appropriate circuitry may be included to make sure that current is only enabled to activate the UV LED's when the handle has moved upwardly into the housing as opposed to when it moves downwardly out of the housing.

In use, the retractable and sanitary utensil 10 may be mounted to a food buffet shield 8, such as with fasteners extended through holes 22 in the base member 18. As the reel 24 is normally biased toward the retracted configuration (FIG. 2), the handle 34 of the utensil body 32 is held substantially inside the housing 12. With the switch 46 turned on, the UV LED's 42 are activated (although a slight movement may be necessary to initiate the lights upon first activating the switch 46 if the sensor 48 is a motion sensor). To use the device to place a food items on a plate, a user may first grasp one or both flanges 40 and pull downwardly until the handle 34 itself may be grasped. Continuing to pull downwardly, the cord is unwound from the reel 24 and the reel 24 is moved to the extended configuration (FIG. 3). Following use, the user may simply release his grasp on the handle 34 and it will move again to the retracted configuration (FIG. 2) as the spring returns to its unbiased condition. When the handle 34 enters the housing 12, the sensor 48 will detect the movement and enable the battery to deliver current to the UV LED's. In this way, any bacteria on the handle is exposed to the UV light and is destroyed in a short amount of time.

Accordingly, the present device maintains a highly sanitary condition at a food buffet by keeping a utensil suspended above the food and sanitizing the utensil handle when not in use.

It is understood that while certain forms of this invention have been illustrated and described, it is not limited thereto except insofar as such limitations are included in the following claims and allowable functional equivalents thereof.

What is claimed is:

1. A food buffet utensil for use with a food buffet having a shield, comprising:
a base member attachable to the food buffet shield;
a housing coupled to said base member and defining a generally hollow interior space and an open bottom;
a reel rotatably situated in said base member;
a cord having a first end connected to said reel and a second end extending from said reel, said reel being selectively movable between a retracted configuration in which said cord is substantially wound about said reel and an extended configuration in which said cord is substantially extended through said housing and through said housing open bottom;
a utensil body having a handle coupled to said second end of said cord, said handle body being displaced from said housing when said reel is at said extended configuration and a portion of said utensil body being positioned in said housing when said reel is at said retracted configuration; and
an ultraviolet LED positioned in said housing such that ultraviolet light is emitted when said ultraviolet LED is electrically energized.

2. The food buffet utensil as in claim 1, further comprising:
a battery positioned in said base member and electrically connected to said ultraviolet LED; and
a switch coupled to said base member and electrically connected to said battery such that said battery is selectively activated to energize said ultraviolet LED.

3. The food buffet utensil as in claim 2, further comprising:
a sensor situated in said housing and electrically connected to said battery and to said ultraviolet LED;
said battery, said ultraviolet LED, said switch, and said sensor forming a circuit that enables said ultraviolet LED to be energized when said switch is enabled and said sensor detects that said handle portion is in said housing.

4. The food buffet utensil as in claim 1, wherein said reel includes a spring attached to said base member such that said reel is normally biased toward said retracted configuration.

5. The food buffet utensil as in claim 1, wherein said utensil body includes one of a pair of tongs, a ladle, a serving fork, or a spoon.

6. The food buffet utensil as in claim 5, wherein said utensil body is removably coupled to said cord second end.

7. The food buffet utensil as in claim 4, wherein said utensil body is pivotally coupled to said cord second end.

8. The food buffet utensil as in claim 1, further comprising a flange fixedly attached to said utensil body and positioned substantially adjacent said second end thereof, said flange being perpendicular to said handle.

9. The food buffet utensil as in claim 3, wherein said utensil body includes one of a pair of tongs, a ladle, a serving fork, or a spoon.

10. A food buffet utensil for use with a food buffet having a shield, comprising:
a base member attachable to the food buffet shield;
a housing coupled to said base member and defining a generally hollow interior space and an open bottom;
a reel rotatably mounted in said base member;
a cord having a first end connected to said reel and a second end extending from said reel, said reel being selectively movable between a retracted configuration in which said cord is substantially wound about said reel and an extended configuration in which said cord is substantially extended through said housing and through said housing open bottom;
a spring situated in said base member and coupled to said reel such that said reel is normally biased toward said retracted configuration;
a utensil body having a handle coupled to said second end of said cord, said utensil body being displaced from said housing when said reel is at said extended configuration and a portion of said utensil body being positioned in said housing when said reel is at said retracted configuration;
an ultraviolet LED positioned in said housing such that ultraviolet light are emitted when said ultraviolet LED is electrically energized;
a battery positioned in said base member and electrically connected to said ultraviolet LED;
a switch coupled to said base member and electrically connected to said battery such that said battery is selectively activated to energize said ultraviolet LED;
a sensor situated in said housing and electrically connected to said battery and to said ultraviolet LED; and
a circuit formed by said battery, said ultraviolet LED, said switch, and said sensor that enables said ultraviolet LED to be energized when said switch is enabled and said sensor detects that said handle is in said housing.

11. The food buffet utensil as in claim 10, wherein said utensil body includes one of a pair of tongs, a ladle, a serving fork, or a spoon.

12. The food buffet utensil as in claim 10, wherein said utensil body is removably coupled to said cord second end.

13. The food buffet utensil as in claim 10, wherein said utensil body is pivotally coupled to said cord second end.

14. The food buffet utensil as in claim 10, further comprising a flange fixedly attached to said utensil body and positioned substantially adjacent said second end thereof, said flange being perpendicular to said handle.

15. The food buffet utensil as in claim 14, wherein said utensil body includes one of a pair of tongs, a ladle, a serving fork, or a spoon.
